(19) United States
(12) Patent Application Publication
(10) Pub. No.: US 2023/0116763 A1
(43) Pub. Date: Apr. 13, 2023

(54) Method and System for Automated Editing of Multiple Video Streams Using Relative Location Based Triggering Events

(71) Applicants: Theodore Zachary Tarr, New York, NY (US); Jeff Tarr, New York, NY (US)

(72) Inventors: Theodore Zachary Tarr, New York, NY (US); Jeff Tarr, New York, NY (US)

(21) Appl. No.: 17/958,886

(22) Filed: Oct. 3, 2022

Related U.S. Application Data
(60) Provisional application No. 63/262,234, filed on Oct. 7, 2021.

(51) Int. Cl. G11B 27/034; H04N 7/18

(52) U.S. Cl. CPC G11B 27/034; H04N 7/181

(57) ABSTRACT

A system and corresponding method for automated editing of multiple video streams includes a computer-implemented method of obtaining multiple video data streams from a plurality of video sources, each video source associated with a moving device from a plurality of moving devices. The locations of the moving devices relative to each other are monitored. The video data streams are processed into a single integrated video file. The processing includes determining a preferred video source for viewing based on a location of a moving device relative to other moving devices, and then switching the preferred video source based on a triggering event relative to the locations of the moving devices relative to each other. A single integrated video file is output to be provided to a viewer or automatically posted to a cloud-based service for storage and distribution.

### RELATED APPLICATION

This application claims the benefit of U.S. Provisional Application No. 63/262,234, filed on Oct. 7, 2021. The entire teachings of the above application are incorporated herein by reference.

### BACKGROUND

Some of the world's most popular spectator sports involve racing events. Viewers enjoy seeing dramatic, high speed passing of runners, skaters, bicyclists, race cars and more. With improved video technology, cameras are often placed on or within the moving racers to provide an in-race view from the vantage point of each racer. In addition, when watching events, knowing the additional data behind the races, such as lead changes, speeds and speed differential, g-forces felt by the racers, and elapsed and remaining time can contribute to keeping the viewers engaged in the outcome of the race.

### SUMMARY

Gathering footage and data from multiple vantage points, and editing it into an integrated and compelling video can be a manual, time consuming and expensive process. It requires camera systems on each racer, sensors on each racer, manual tracking of each pass or significant event (which can be extensive for large races and hard to observe over a large race track), manual post production video splicing, manual calculations of sensor values, manually superimposing sensor information into the video, and manual uploading or transferring of the completed video to a service for viewing. For live events, production teams must monitor video and manually switch a viewer display to a selected video source. For non-professional events or spontaneous or ad-hoc activities, there may be racers that do not know each other, making it difficult or impossible to share video footage and data.

For race car events, racers are outfitted with cameras to record the racers' individual views of the event. That footage is either recorded on the actual camera itself and/or wirelessly transmitted to a central recording facility. A person automatically manages and manipulates the recordings to create highlight reels showing passes, adds in graphics showing any additional data or metrics, and then uploads the final video for viewing. This is a time-consuming process, an expensive process, and requires dedicated trained resources to do the work. For smaller scale or informal race events, this video editing process can be cost prohibitive.

Embodiments of a system and corresponding method for automated editing of multiple video streams includes obtaining multiple video data streams from a plurality of video sources, each video source associated with a moving device from a plurality of moving devices. The locations of the moving devices relative to each other are monitored. The video data streams are processed into a single integrated video file. The processing includes determining a preferred video source for viewing based on a location of a moving device relative to other moving devices, and switching the preferred video source based on a triggering event relative to the locations of the moving devices relative to each other. A single integrated video file can then be output to be provided to a viewer or automatically posted to a cloud-based service for storage and distribution.

In some embodiments, the single integrated video file is provided to a viewer through a live video stream. In other embodiments, the triggering event is a change in a race lead between moving devices, and may further include determining the preferred video source is the leading moving device. In yet other embodiments, the system may determine the preferred video source is the moving device behind a leading moving device.

In some embodiments, other moving devices may be detected within a field of view of each moving device and the preferred video source may be switched based on whether any moving devices are within the field of view of each moving device.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates a system according to an embodiment of the present disclosure.

FIG. 2A is an alternate system according to an embodiment consistent with the present disclosure.

FIG. 2B illustrates example views from the video sources from FIG. 2A and a sample display from the integrated video according to principles of the present disclosure.

FIG. 3 is a flow diagram that illustrates an example process for initial setup of a device according to principles of the present disclosure.

FIG. 4 is a flow diagram that illustrates example processes for handling triggering events and video acquisition at a device during a race according to principles of the present disclosure.

FIG. 5 is a flow diagram that illustrates an example process for post-race processing at a device according to principles of the present disclosure.

FIG. 6 is a flow diagram that illustrates an example process for additional video processing at a device according to principles of the present disclosure.

FIG. 7 is a block diagram of an example internal structure of a computer in which various embodiments of the present disclosure may be implemented.

### DETAILED DESCRIPTION

A description of example embodiments follows.

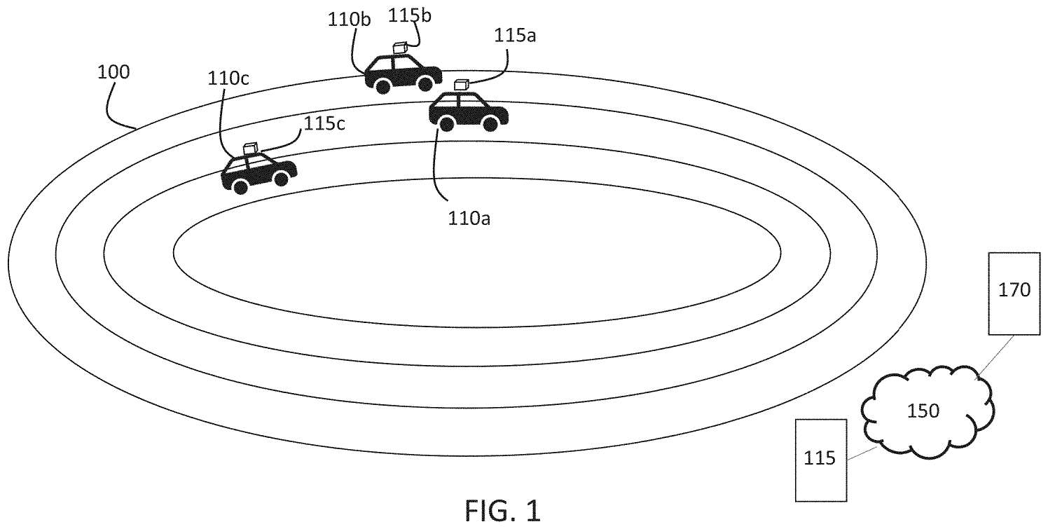

As illustrated in FIG. 1, a race track 100 may have multiple racers 110a-c (shown in FIG. 1 as vehicles; the racers could also be on other moving devices such as motorcycles, bicycles, etc. or could simply be runners). Every racer has a video recording device 115a-c that serves as a video source for the system. The video recording device may be a dedicated video recording device designed specifically for recording footage for racing events, an off-the-shelf device with video recording capabilities, or a smartphone that has video and sound recording capabilities. The video recording device includes a transmission capability, such as a wireless radio transceiver that allows for high resolution distance ranging between devices (such as ultra-wideband (UWB)). In some embodiments, the video recording device also includes a GPS position receiver, a battery sufficient for the length of the race or hardwired power source, and an internet backhaul capability (e.g., Wi-Fi, Cellular, Bluetooth, etc.). In some embodiments, there may be third-party devices that provide additional data points, for example a Bluetooth or Wi-Fi OBD2 vehicle gateway data transmitter that transmits vehicle data or a wearable device that transmits or shares data related to the racer's physiology (e.g., heart rate, temperature, etc.).

Each device 115a-c has a pre-programmed universally unique identifier (UUID). This UUID may be mapped to the racer's name, demographic, and privacy information stored in a cloud-based server 170.

In an embodiment consistent with principles of the disclosure, prior to the start of a race, each racer activates the recording mode by pressing a button or telling the “app” (e.g., through voice activation) to start recording. For example, in FIG. 1, the video recording devices 115a-c (collectively 115) can transmit the activation event over the internet 150 to a cloud-based server 170 indicating that an event has started, and include the GPS position, date, time, and UUID of its corresponding racer 110a-c.

In some embodiments, activation may occur based on the racer arriving at, or passing by, a predetermined position as detected by the GPS. In yet other embodiments, the video recording devices 115a-c may begin recording prior to activation, but activation will tell the system that the event has started for purposes of processing the video data streams.

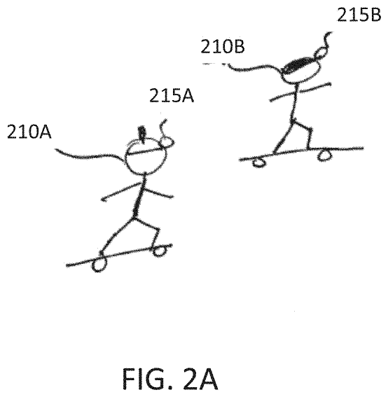

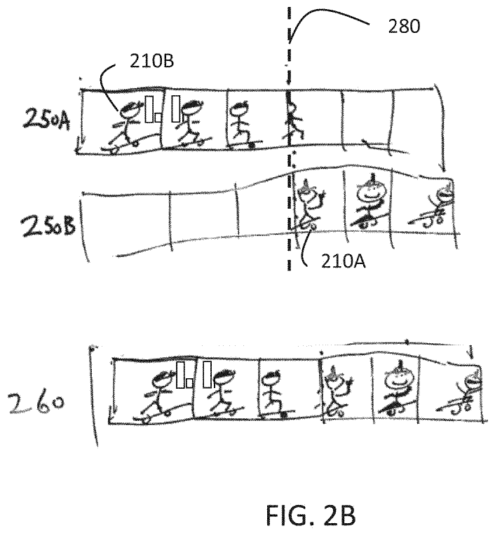

In an alternate embodiment consistent with principles of the disclosure, as shown if FIG. 2A, multiple racers 210A and 210B may be equipped with video cameras 215A and 215B respectively, that are in communication with a transmitter (not shown). Alternatively, the video cameras may be equipped with a transmitter, as may be the case with the video camera on a smartphone. These racers may be traveling together to a particular destination, but without any formal or marked race path or track.

Once a video recording device (video recording device 115a-c or video cameras 215A and 215B) begins recording video and audio, it may use a wireless radio transceiver, and send a “is anyone there encoded with its own UUID?” message and listen for responses for other racers. All responses are cached on the local device.

The video recording device listens for “is anyone there?” messages on the wireless radio transceiver and answers with its own UUID. The video recording device caches the host's UUID. For each cached UUID, the video recording device is programmed to triangulate the relative positional information which includes distance and direction. With this positional information the device is classified as being relatively: in front, next to, or behind the racer. The relative calculation takes into account the historical position of the UUID as a curvy road course could give the false impression that another device has moved ahead or behind because of a path that circles back on itself. When a UUID changes its relative position, that is it moves from being in front/next to/behind to a new state, the device logs the exact time, UUID, and state change of the pass to be used later for automated video creation.

When the race is over, each device stops recording by the racer pressing a button in the app or the app may automatically stop recording when it believes the event is over because other conditions are met: no other participating racers have been observed for a certain amount of time, the device is about to turn off from lack of battery charge, the GPS position of the device has not changed for a certain amount of time, etc.

In the embodiment described with respect to FIG. 1, once the video recording devices 115a-c have finished, the system begins the video processing loop. In other embodiments, such as with the racers show in FIG. 2A, the system can begin the video processing loop while the video recording devices 215A, 215B are still recording, and determine the preferred video source as the racers are still actively moving.

In some embodiments, a single controller can track the racers within the system to identify and recognize which racers are participating in the race for video recording purposes, and then receive the corresponding video. A racetrack could have its own physical controller on premises (e.g., a physical device, or software executed on a cellphone or computer). In this scenario the controller broadcasts a wireless signal to tell all the racers to activate. This can be linked to the official timing of the race. It can also be told beforehand through emails and/or cell phone numbers of racers to invite them to the event beforehand.

In yet other embodiments, the single controller can be a processor on a device of a particular racer for activating other racer devices within the system for purposes of tracking them as part of the system and send messages to activate the recording functions of each racer as a race begins. Recognizing the racers that are participating in the race may be possible based on a pre-registration of the racer to a particular event, or based on devices within an established social network, or based on acceptance of an invitation to participate in a race. For example, a controller racer can send an invitation through a social network or through targeted emails or messages stating a time or place for a racing event. Recordings from invited racers can then be monitored and processed as part of the larger system. In yet other embodiments, each racer participant may be capable of obtaining and processing the video streams within the system of racers to create a single integrated video file based on that user's particular processing preferences (e.g., perspective from the last place racer, or switching perspectives to a racer behind racers passing each other, etc.). This individualized processing may occur in the cloud, with the individualized processed video made available to one or more racer participants.

As shown in FIG. 2B, the system can cut the footage into parts where passing has occurred, where passing has been defined as a triggering event for the video editing or perspective switching. For example, the camera 215A of racer 210A in FIG. 2A may obtain video data 250A or footage (shown in FIG. 2B as video frames) from their vantage point, including images of racer 210B. Likewise, the camera 215B of racer 210B in FIG. 2A may obtain video data 250B from its own vantage point, including images of racer 210A. The video data stream from each moving device will have the relevant UUIDs assigned to them for easy sharing. The footage used for an integrated video may start from one perspective a few seconds before the pass was initiated 280, and end a few seconds after the pass has completed. In addition to the video and audio footage of the pass, a set of metadata may be generated to accompany the footage that may include, but is not limited to, GPS position of the recording device, speed, altitude, weather conditions, date, time, name of venue, or name of driver. This metadata may be defined by the user, or automatically calculated based on data sources available locally and through the internet.

In some embodiments, the system may also detect other racers or other objects using traditional image processing techniques, such as object segmentation and object recognition, within a field of view of each racer. In an example using computer vision, a system can operate as follows:

1. The software app records footage from racer #1.

2. During the race the software app records two other cars (racers #2 and #3) in the video that are not using the software app.

3. After the race the software app asks racer #1 for the email address or cell phone number of racers #2 and #3.

4. The system automatically emails and/or texts racers #2 and #3 asking them if they would like a copy of the footage and if they could upload their own videos, should they have any.

5. Anything that racers #2 and #3 upload is analyzed as if the software app was running live during the race and clips are integrated with the other users as determined.

Artificial Intelligence (AI) processes may use image recognition in the system as an additional trigger for switching the preferred video source for the integrated video based on whether any moving devices (e.g., other racers) are within the field of view of each moving device. For example, if a car spins off the track or has some other sort of crash, the software agent could detect a crashed car and use that information to automatically cut to that footage from any of the participants as well. Another variation may be to use the field of view of the racer crashing into something. As another example, if the racer passes by a particular object that has been identified as an object of interest (e.g., a local landmark, a type of animal, or a type of vehicle) the system may switch to that racer's video feed. As each device records the video data, markers of these detected objects may be flagged in the video data associated with each UUID.

For each UUID, if it is still in wireless range the video recording device sends the appropriate video clips wirelessly to each UUID via a peer to peer network method. If the UUID is not in range, or is unable to receive the clip at that time, the video recording device uploads the clips to a cloud-based server for the other UUID devices to download when able. This allows racers who do not know one another to automatically receive relevant clips in a privacy protected manner, without needing to share the actual identity of other racers.

The video recording device checks with the cloud-based server to see if there are video clips available for downloading that it did not receive via the peer to peer network method. Available clips and metadata may be downloaded via the internet connection a from the cloud-based server. In the event a clip becomes available at a later time, perhaps because another device had a delay in uploading to the cloud, a callback notification may be generated by the cloud-based server to alert the device of new footage that will re-trigger this process. In some embodiments, the device may be a handheld device such as a mobile phone or laptop. In other embodiments, the device may be a processor on a cloud-base server.

Referring again to FIG. 2B, the video recording device next stitches together the footage into a single integrated video with audio 260. For each clip within the single integrated video, the user's stated preference for metadata will be superimposed on the video to display information about the event and the pass. If desired by the user, special effects consisting of video and audio changes can be added and applied to the clips during the processing to make them more exciting. Once completed this single integrated video is stored on the local video recording device and can be easily posted to social media, saved in a video album, or exported for other use.

After a race, the user now has a video showing all of the passes from users of the system in a single integrated video file. This single integrated video file, complete with audio and metadata superimposed in, is readily available for sharing, broadcasting, and long-term storage. No manual processing was required to create it.

Users could manually record a race, collect all the footage from the participating devices, then manually search for passes, manually splicing the videos, reassembling them, and then posting. Given the difficulties of sharing footage amongst users, who may not know each other's identities or means of contact, this could be impossible or take a significant amount of time. With the approach of the present disclosure, these difficulties are avoided.

The term “system” is used throughout to refer to one or more of the video recording devices 115a-c or 215A, 215B, or other such video recording devices, as programmed to implement the features described herein for automated editing of multiple video streams based on one or more triggering events.

In some embodiments, the processor may be located locally on the same device as the video source. In other embodiments, it may be located on a remote general-purpose computer or cloud-computer. The interface may include a display on a networked computer, a display on a handheld device through an application, or a display on a wearable device.

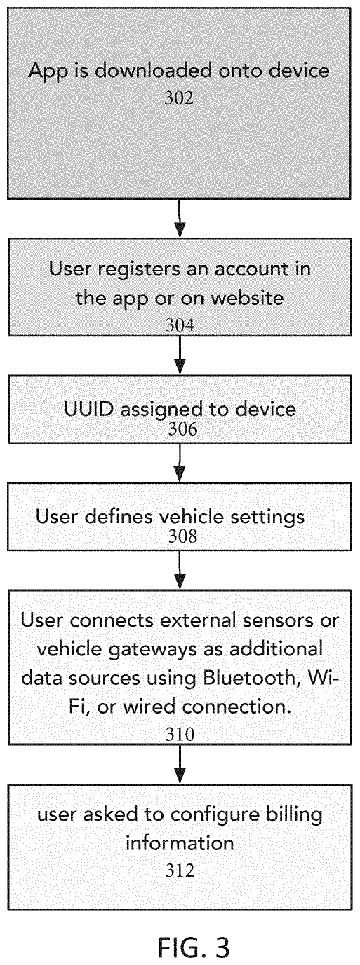

FIG. 3 is a flow diagram that illustrates an example process for initial setup of a video recording device according to principles of the present disclosure. At 302 the video processing app is downloaded onto the device. At 304 the user registers an account through the app or via a website. At 306 a UUID is assigned to the user. The user defines vehicle settings at 308. At 310 the user connects external sensors or vehicle gateways (e.g., OBD2) as additional data sources using Bluetooth, Wi-Fi or through a wired connection. The user may be asked to configure billing information at 312. It should be noted that these are example steps for initial setup.

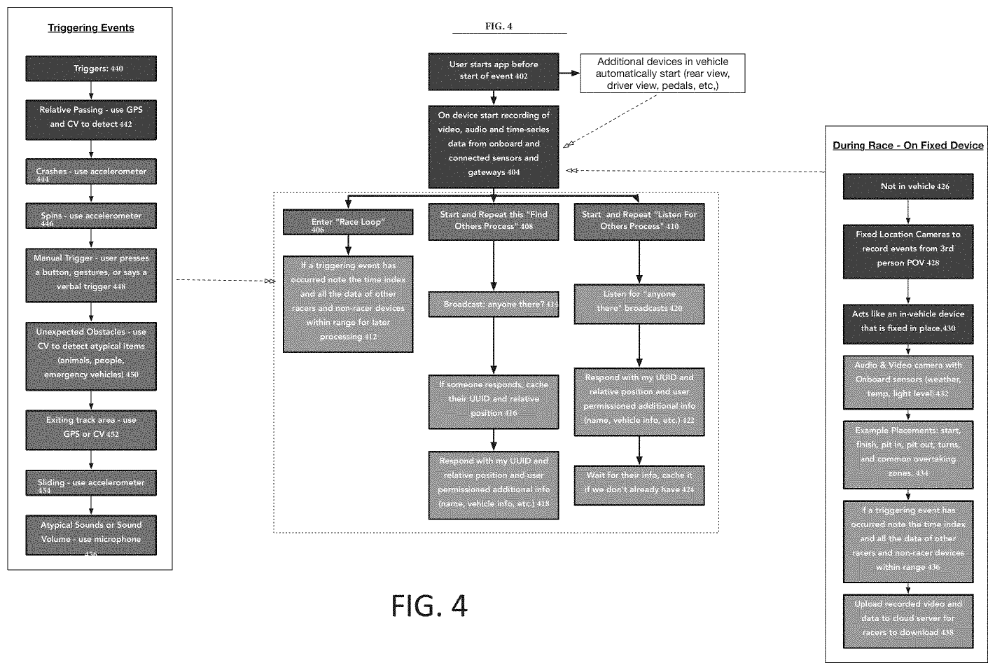

FIG. 4 is a flow diagram that illustrates example processes for handling triggering events and video acquisition at a device during a race according to principles of the present disclosure. The center portion of FIG. 4 shows steps of processes running on the video recording device. On the right portion of FIG. 4 is shown process steps related to fixed devices that may function in certain aspects as the video recording devices that are moving in the race event in order to provide additional video sources for processing by the other video recording devices. On the left portion of FIG. 4 are shown example triggering events that may be independent or dependent on each other.

Referring to the center portion of FIG. 4, the user starts the app before the start of a race event at 402. In some embodiments, as noted above, there may be additional devices in the vehicle, and such devices may be started based on the start of the race event. At 404 the video recording device begins recording of video, audio, and time-series data from onboard and connected sensors and vehicle gateways.

At 406 the video recording device enters a repeated “race loop” 406 wherein, if a triggering event has occurred, the time index and all the data of other relevant racers and non-racer devices within range is recorded for later processing at 412.

At 408 the video recording device starts and repeats a “find others” process. In this process, the device broadcasts the “is anyone there?” message. If another device responds, the video recording device caches the UUID and relative position of the responding device(s) at 416. The video recording device responds in turn by transmitting its UUID and relative position and any user-permissioned additional information (e.g., name, vehicle information, etc.) at 418.

At 410 the video recording device starts and repeats a “listen for others” process. In this process, the device listens for “is anyone there?” message broadcasts from other devices at 420. Upon detecting such a message, the video recording device responds by transmitting its UUID and relative position and any user-permissioned additional information (e.g., name, vehicle information, etc.) at 422. At 424 the device may cache the UUID of a responding device.

Referring to the right portion of FIG. 4, the process relates to a fixed device (e.g., camera) not in a vehicle 426. The fixed location cameras may be positioned to record events from a third-person point of view 428. Functionally, with respect to the video processing features of the present disclosure, the fixed device acts like an in-vehicle device 430. The fixed device may include onboard sensors (e.g., weather, temperature, light level, etc.) 432. Example placements for the fixed device may include start, finish, pit in, pit out, turns, and common overtaking zones 434.

At 436 if a triggering event has occurred, the time index and all the data of relevant racers and non-racer devices within range is recorded for later processing. At 438 the fixed device uploads recorded video and data to the cloud-based server for use by the racers to download.

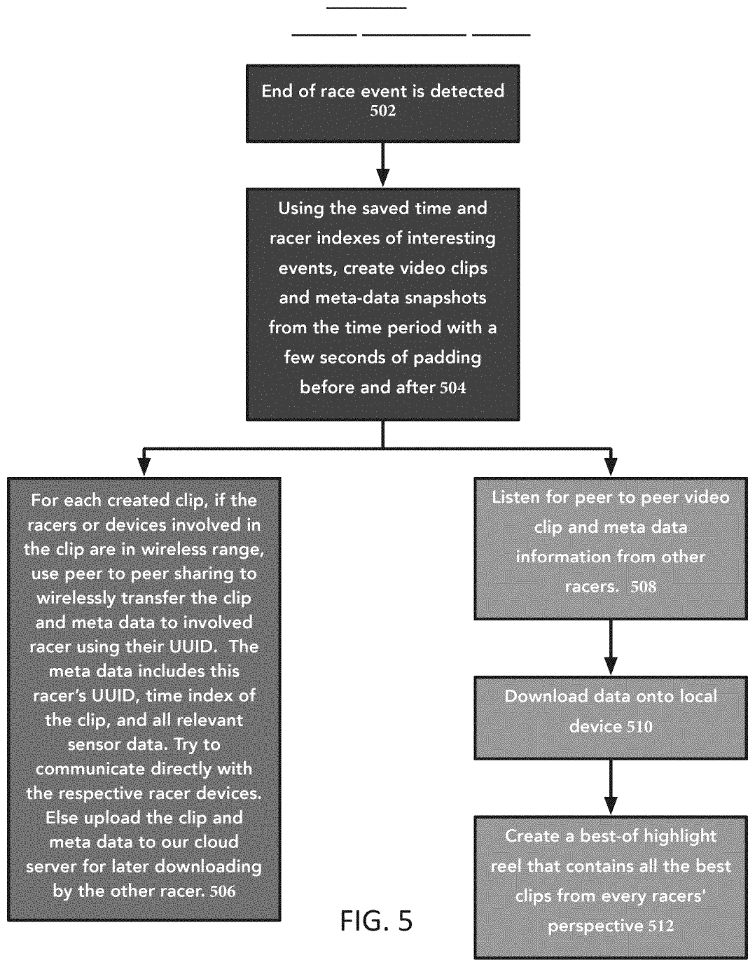

FIG. 5 is a flow diagram that illustrates an example process for post-race processing at a device according to principles of the present disclosure. This process begins when the end of a race is detected at 502. Using the saved time and racer indexes of interesting/triggered events, the device at 504 creates video clips and metadata snapshots from the relevant time period(s) with several seconds of padding before and after. At 506 for each created clip, if the racers or devices involved in the clip are in wireless range, the video recording device uses peer to peer sharing to wirelessly transfer the clip and metadata to the corresponding devices of any involved racers using their respective UUID. The metadata includes this racer's UUID, time index of the clip, and all relevant sensor data. The communication is preferably directly with the respective racer devices. Otherwise, the clip and metadata may be uploaded to the cloud-based server for later downloading by the other racer(s).

At 508 the video recording device listens for peer video clip and metadata information from other racers. At 510 the device downloads data locally for further processing. At 512 the device creates a “best-of” highlight reel, e.g., as a single integrated video file. This highlight reel may contain the best clips from each racer's perspective.

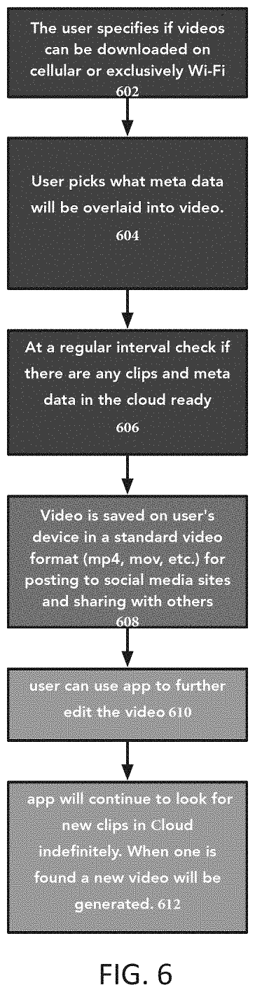

FIG. 6 is a flow diagram that illustrates an example process for additional video processing at a device according to principles of the present disclosure. At 602 the user may specify if video clips can be downloaded via cellular or exclusively via Wi-Fi. At 604 the user may select the metadata that is to be overlaid onto the video. At a regular interval the device checks if there are any clips and metadata in the cloud ready to use at 606. At 608 the video is saved on the user's device in a standard video format (e.g., mp4, mov, etc.) for posting to social media sites and sharing with others. At 610 the user has the capability to further edit the video. The app will continue to look for new clips in the cloud for subsequent generation of new or updated highlight reels at 612.

It should be understood that the example embodiments described above may be implemented in many different ways. In some instances, the various methods and machines described herein may each be implemented by a physical, virtual or hybrid general purpose computer having a central processor, memory, disk or other mass storage, communication interface(s), input/output (I/O) device(s), and other peripherals. The general-purpose computer is transformed into the machines that execute the methods described above, for example, by loading software instructions into a data processor, and then causing execution of the instructions to carry out the functions described, herein.

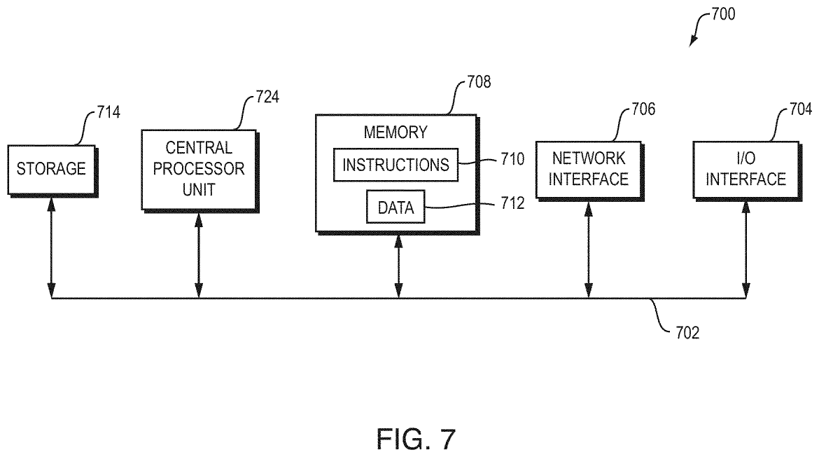

FIG. 7 is a block diagram of an example of the internal structure of a computer 700 in which various embodiments of the present disclosure may be implemented. The computer 700 contains a system bus 702, where a bus is a set of hardware lines used for data transfer. The system bus 702 is essentially a shared conduit that connects different elements of a computer system (e.g., processor, disk storage, memory, input/output ports, network ports, etc.) that enables the transfer of information between the elements. Coupled to the system bus 702 is an I/O interface 704 for connecting various I/O devices (e.g., camera, microphone, keyboard, mouse, displays, printers, speakers, etc.) to the computer 700. A network interface 706 allows the computer 700 to connect to various other devices attached to a network. The network interface 706 may be employed as a communications interface in the video recording device 115a-c, for example, disclosed above with regard to FIG. 1. Memory 708 provides volatile or non-volatile storage for computer software instructions 710 and data 712 that may be used to implement an example embodiment of the present disclosure, where the volatile and non-volatile memories are examples of non-transitory media. Disk storage 714 provides non-volatile storage for computer software instructions 710 and data 712 that may be used to implement embodiments of the present disclosure. A central processor unit 724 is also coupled to the system bus 702 and provides for the execution of computer instructions. The computer software instructions 710 may cause the central processor unit 724 to implement methods disclosed herein. The central processor unit 724 may be employed as the processor of the video recording device 115a-c of FIG. 1, disclosed above, for example.

Embodiments may typically be implemented in hardware, firmware, software, or any combination thereof.

In certain embodiments, the procedures, devices, and processes described herein constitute a computer program product, including a non-transitory computer-readable medium, e.g., a storage medium such as one or more high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices or any combination thereof. Such a computer program product can be installed by any suitable software installation procedure, as is well known in the art. In another embodiment, at least a portion of the software instructions may also be downloaded over a cable, communication and/or wireless connection.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etcetera.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method, the method comprising:
obtaining multiple video data streams from a plurality of video sources, each video source associated with a moving device from a plurality of moving devices;
monitoring the locations of the moving devices relative to each other;
processing the video data streams into a single integrated video file, the processing including:
i) determining a preferred video source for viewing based on a location of a given moving device relative to other moving devices;
ii) switching the preferred video source based on a triggering event relative to the locations of the moving devices relative to each other; and
outputting the single integrated video file.

2. The method of claim 1 wherein outputting the single integrated video file is to a viewer through a live video stream.

3. The method of claim 1 wherein the triggering event is a change in a race lead between moving devices.

4. The method of claim 3 wherein switching the preferred video source includes selecting the leading moving device.

5. The method of claim 3 wherein switching the preferred video source includes selecting the moving device behind the leading moving device.

6. The method of claim 3 further including detecting other moving devices within a field of view of each moving device and switching the preferred video source based on whether any moving devices are within the field of view of each moving device.

7. The method of claim 1 wherein outputting of the single integrated video file is to a cloud-based service for storage and distribution.

8. A system for automated editing of multiple video streams, the system comprising:
a plurality of video sources for obtaining a video data stream associated with each video source, wherein each video source is associated with a moving device and is configured to transmit a location of the moving device;
a processor configured to:
i. receive the video data streams of each of the moving devices and their associated locations;
ii. process the video data streams into a single integrated video file by (1) determining a preferred video source for viewing based on a location of a given moving device relative to other moving devices, and (2) switching the preferred video source based on a triggering event relative to the locations of the moving devices relative to each other;
iii. output the single integrated video file.

9. The system of claim 8 wherein the video source is a device in wireless communication with a moving device.

10. The system of claim 8 wherein the video sources include cameras on smartphones.

11. The system of claim 10 further comprising a display for displaying the single integrated video file.

12. The system of claim 11 wherein the display is a smartphone.

13. The system of claim 10 wherein the single integrated video file is provided to a viewer through a live video stream.

14. The system of claim 8 wherein the processor is housed in a moving device.

15. The system of claim 8 wherein the processor is in a remote server in communication with the video sources.

16. The system of claim 8 wherein the triggering event is a change in a race lead between moving devices.

17. The system of claim 16 wherein the processor is configured to determine that a leading moving device is the preferred video source.

18. The system of claim 16 wherein the processor is configured to determine that the moving device behind a leading moving device is the preferred video source.

19. The system of claim 8 wherein the processor is further configured to detect other moving devices within a field of view of each moving device and further switch the preferred video source based on whether any moving devices are within the field of view of each moving device.

20. The system of claim 8 wherein the processor is further configured to output the single integrated video file to a cloud-based service for storage and distribution.
